(19) United States
(12) Patent Application Publication
(10) Pub. No.: US 2014/0028030 A1
(43) Pub. Date: Jan. 30, 2014

(54) ENERGY GENERATION AND MULTIPLIER STATION FOR THE HIGH DEMAND OF THE POWER DISTRIBUTION AND PROCESS THERETO

(71) Applicant: Edson DE SOUZA, Campinas (BR)

(72) Inventor: Edson DE SOUZA, Campinas (BR)

(21) Appl. No.: 13/603,987

(22) Filed: Sep. 5, 2012

(30) Foreign Application Priority Data
Jul. 25, 2012 (BR) 10 2012 018489-3

(51) Int. Cl. H02K 7/18

(52) U.S. Cl. 290/1 R

(57) ABSTRACT

An apparatus comprises a station that multiplies and distributes power and comprises an electric generator, a segment of circular arc and at least one torque gearbox with low power consumption. Each of the at least one torque gearbox includes two dc electric motors, a hydraulic turbine, two hydraulic pumps, a cooling water condenser, a water storage tank, a pulley, and an switchgear frame having circuit breakers, relays, electrical cables, an electronic control, voltage, current and power displays, a bridge rectifier, a control device for engines with direct current and actuation buttons.

The present patent application relates to an “ENERGY GENERATION AND MULTIPLIER STATION FOR THE HIGH DEMAND OF THE POWER DISTRIBUTION AND PROCESS THERETO” of an inventive solution to obtain energy through an unprecedented process achieved by a set of equipment in order to generate clean energy.

In turn, the object of this patent becomes innovative before the energy generation systems currently used in the art, belonging to the branch of power production, qualified on the whole process as clean energy.

In order to better clarify this patent application, a brief explanation for the prior art will be given where it will be possible for those skilled in the art to recognize its limiting aspects, and then at a later date, to discuss the advantages and aggregated solutions achieved with the subject disclosed in the inventive scope.

Currently, various sources of energy are used, such as hydraulic, fossil, solar, nuclear, wind, biomass, geothermal, chemical (battery bank) and gravitational.

The sources can be renewable or nonrenewable. The non-renewable correspond to finite natural resources in the environment, such as uranium, manganese and fossil fuels—such as oil, coal and natural gas. As for the renewable sources, since exploited by man, they are reconstituted spontaneously or through conservation practices. These include air, water, vegetation, sun and geothermal energy sources.

The forms of production differ according to the generator source, the impact on the environment and especially the economic viability. Both renewable and nonrenewable sources have advantages and disadvantages in relation to the three factors mentioned above.

The renewable resources provided energy has a great advantage by not harming the environment, they are called clean energy. But for their generation a high financial investment is required, beside some sources, such as hydroelectric which require the displacement of the resident population for the plant's construction.

As for the non-renewable energy sources, these are considered low cost sources, as they have a greater ease of distribution and transportation, besides having technology domain for their extraction. Its disadvantage is the air pollution with the release of greenhouse gases, mainly carbon dioxide, contributing to the greenhouse effect.

By analyzing existing features, it is possible to identify ways to solve such problems where the applicant discloses a preferred embodiment of the present invention.

The “ENERGY GENERATION AND MULTIPLIER STATION FOR THE HIGH DEMAND OF THE POWER DISTRIBUTION AND PROCESS THERETO” comprises a process for multiplication and distribution which is more efficient, alternative and without harming the environment.

The present invention consists of a process for multiplying the energy provided in any external environment, such as hydro, fossil, solar, nuclear, wind, biomass, geothermal, gravitational, chemical and then distributes it to a substation grid.

This is possible through a “gearbox torque”, together with a circular arc segment, an electric generator and its mechanical, hydraulic and electrical high-tech, multiply the physical properties of strength and torque. Thus, it is possible to generate energy available for consumption above the power supply system.

As a complement to the basic descriptions cited above and to better understand the “ENERGY GENERATION AND MULTIPLIER STATION FOR THE HIGH DEMAND OF THE POWER DISTRIBUTION AND PROCESS THERETO”, are attached figures illustrating the mounting of a preferred embodiment which results in a feature unmatched in power generation.

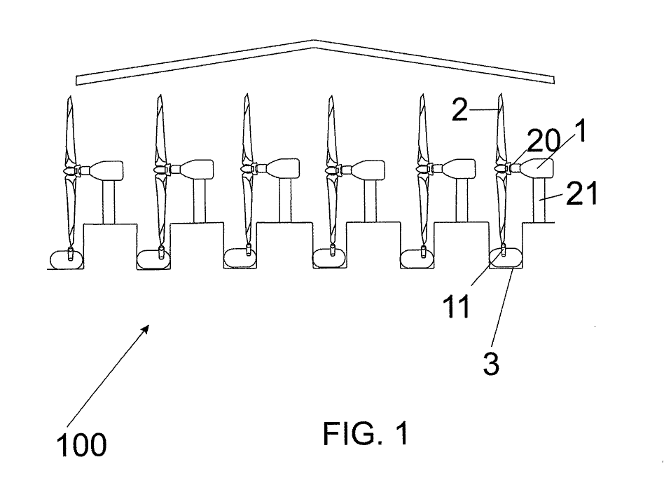

FIG. 1 represents the “ENERGY GENERATION AND MULTIPLIER STATION FOR THE HIGH DEMAND OF THE POWER DISTRIBUTION AND PROCESS THERETO”;

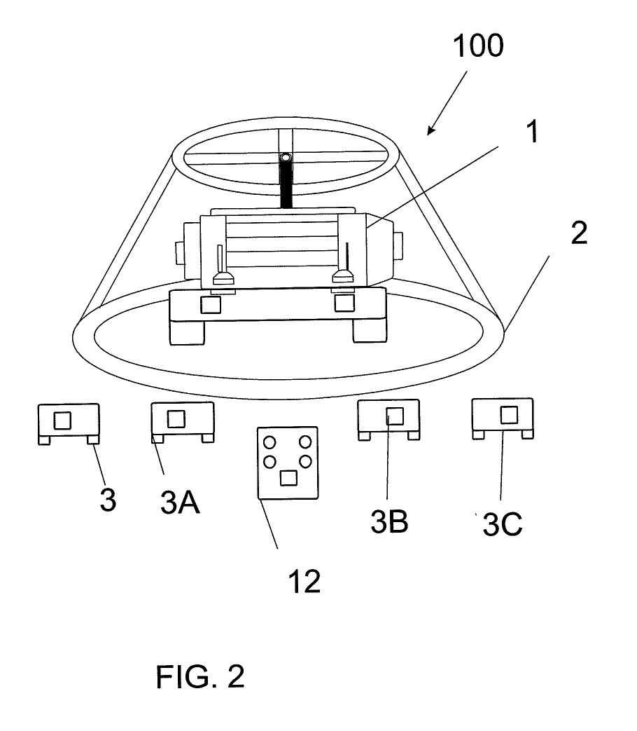

FIG. 2 depicts the electricity generator of the “ENERGY GENERATION AND MULTIPLIER STATION FOR THE HIGH DEMAND OF THE POWER DISTRIBUTION AND PROCESS THERETO”;

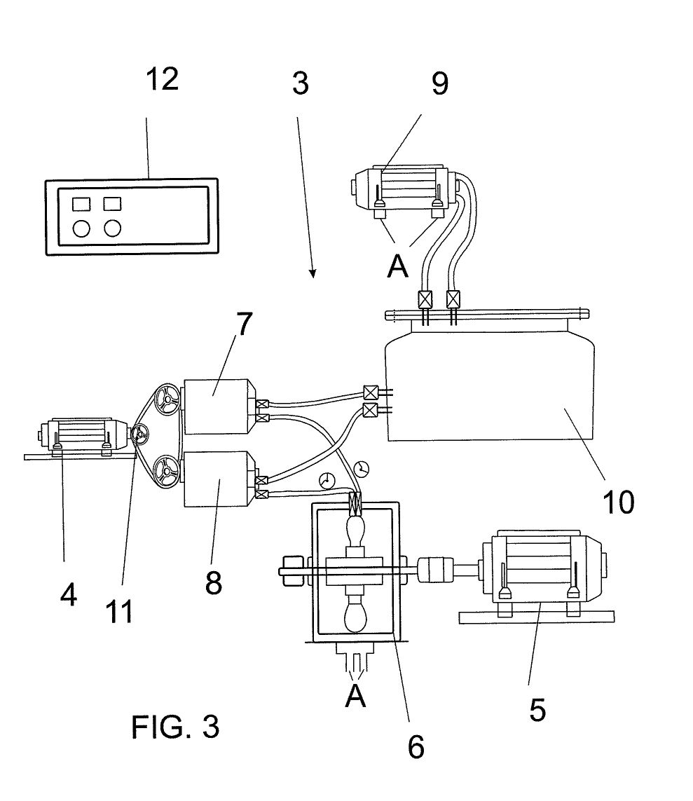

FIG. 3 shows each torque gearbox of the “ENERGY GENERATION AND MULTIPLIER STATION FOR THE HIGH DEMAND OF THE POWER DISTRIBUTION AND PROCESS THERETO”;

The following detailed description should be read and understood with reference to the drawings provided, in which these are highly diagrammatic, representing a preferred embodiment for the equipment, and are not intended to limit the scope of the invention, being the latter limited only to the set of accompanying claims.

According to the illustrations and its details, the present invention patent application, “ENERGY GENERATION AND MULTIPLIER STATION FOR THE HIGH DEMAND OF THE POWER DISTRIBUTION AND PROCESS THERETO” relates to a process that includes a station (100) that multiplies and distributes clean energy consisting of at least one electrical generator (1), a circular arc segment (2) and at least one torque gearbox (3) with low power consumption, a pulley (11), an arc cube (20) mounted on a support tower (21). FIG. 1 shows a set of components in series forming the station.

In a preferred embodiment of the present invention four gearboxes (3) (3A) (3B) and (3C) are provided in which each of these gearboxes torque consists of two direct current DC electrical motors (4) (5), a hydraulic turbine (6), two hydraulic pumps (7) (8), a water cooling condenser (9) and a water storage tank (10), a pulley (11) and a switchgear frame (12) with circuit breakers, relays, electrical cable, electronic control, voltage, current and power displays, bridge rectifier, control device for engines with direct current and finally actuation buttons.

The “ENERGY GENERATION AND MULTIPLIER STATION FOR THE HIGH DEMAND OF THE POWER DISTRIBUTION AND PROCESS THERETO” is part of a process consisting of steps, preferably as described below, revealed in detail.

At first, the energy referred as external source feeds the switchgear frame (12), causing the dc electric motor (5) connected to the hydraulic turbine (6) to be in operation.

When the electronic control is active, the second dc electric motor (4) is interconnected to the two high flow and pressure hydraulic pumps (7) and (8) and the cooling water condenser (9).

A hydraulic fluid comes out of the high pressure and flow hydraulic pumps (7) (8) towards the hydraulic turbine (6) generating a high level of torque on the output shaft of the hydraulic turbine which is coupled to a pulley (11). The hydraulic fluid returns through the cooling water condenser (9), restarting the cycle.

All the force generated by the DC motor (5) and hydraulic turbine (6) is available on the pulley (11) of this hydraulic turbine (6) and transmitted through the contact between the pulley (11) and the circular arc segment (2).

This force (torque) is multiplied by a specific value mathematically given by: diameter of the circular arc segment (2)/pulley diameter (11).

The contact between the pulley (11) and the circular arc segment (2), both rotary, drives the electric generator (1), which is connected to the center of the circular arc segment (2). Thus, it begins to supply electricity.

Obviously the electricity generator provides varied voltages of 127 volts, 220 volts and 380 volts, the powers ranging from 50 kW to 6000 kW, operating at a rotor speed of 10 rpm to 150 rpm and having a frequency of 50 Hz to 60 Hz.

In a preferred embodiment and by way of example, a system with three gearboxes torque is provided with a total consumption of 150 kW, torque available in the pulleys having a diameter of 30 cm and each pulley with 300 Nm totaling 900 Nm at 5.600 RPM, which is in contact with the circular arc segment with a diameter of 4,000 cm related to the electric generator, operating on its axis at 42 RPM and rated power supply of 1,000 kW.

These abovementioned power values in kilowatts may have a variation according to: the power supply of the electric generator, the diameter of the circular arc segment and the quantity and power of the gearbox torque.

The embodiment of the “ENERGY GENERATION AND MULTIPLIER STATION FOR THE HIGH DEMAND OF THE POWER DISTRIBUTION AND PROCESS THERETO” described in this invention constructive detail topic is provided only as an example. Alterations, modifications and variations can be made to any other particular constructive embodiments by those skilled in the art without, however departing from the purpose disclosed in the patent application, which is defined by the appended claims.

It appears from what has been described and illustrated that the “ENERGY GENERATION AND MULTIPLIER STATION FOR THE HIGH DEMAND OF THE POWER DISTRIBUTION AND PROCESS THERETO”, now claimed, fits the rules governing the patent in light of the Industrial Property Law, deserving the privilege for what is was exposed to.

1. An apparatus, comprising:
a station that multiplies and distributes power comprising:
an electric generator;
a circular arc segment; and
at least one torque gearbox with low energy consumption.

2. The apparatus according to claim 1, wherein each of the at least one torque gearbox comprises:
two dc electric motors;
a hydraulic turbine;
two hydraulic pumps;
a cooling water condenser;
a water storage tank;
a pulley; and
a switchgear frame having circuit breakers, relays, electrical cables, an electronic control, a voltage display, a current display, and a power display, a bridge rectifier, a control device for engines with direct current and finally actuation buttons.

3. The apparatus according to claim 2, wherein an external energy source means feeds the switchgear frame, causing a first dc electric motor interconnected to the hydraulic turbine to be in operation,
wherein when the electronic control is active, a second dc electric motor, which is interconnected with the two hydraulic pumps and the cooling water condenser, a hydraulic fluid comes out of the hydraulic pumps towards the hydraulic turbine generating a high level of torque on an output shaft of the hydraulic turbine, which is coupled to the pulley,
wherein the hydraulic fluid returns through the cooling water condenser, restarting the cycle,
wherein all the power generated by the first dc motor and the hydraulic turbine is available on the pulley and is transmitted through a contact between the pulley and the circular arc segment,
wherein the torque is multiplied by a specific value mathematically given by: a diameter of the circular arc segment pulley diameter, and
wherein the contact between the pulley and the circular arc segment, both in rotation, drives the electric generator, which is connected to Ate center of the circular arc segment.

4. The apparatus according to claim 1, wherein the at least one torque gearbox comprises four torque gearboxes.
